(19) United States
(12) Patent Application Publication
(10) Pub. No.: US 2008/0237938 A1
(43) Pub. Date: Oct. 2, 2008

(54) Method for manufacturing information recording medium, method of transferring concavo-convex pattern, and transfer apparatus

(75) Inventors: Narutoshi Fukuzawa, Tokyo (JP); Minoru Fujita, Tokyo (JP); Daisuke Yoshitoku, Kawasaki-shi (JP); Mitsuru Takai, Tokyo (JP); Kazuya Shimakawa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/078,166

(22) Filed: Mar. 27, 2008

(30) Foreign Application Priority Data
Mar. 30, 2007 (JP) 2007-94798

(51) Int. Cl. B29C 35/08

(52) U.S. Cl. 264/496; 425/174.4

(57) ABSTRACT

A method for manufacturing an information recording medium, a method of transferring a concavo-convex pattern, and a transfer apparatus are provided which are capable of curing a resin material with reliability even when using a light-transmitting stamper repeatedly. A stamper made of a light-transmitting resin, having a predetermined concavo-convex pattern formed on its transfer area, is inspected for an optical characteristic. The stamper is brought into contact with an energy-ray curable resin material applied to an object to be processed, thereby transferring the concavo-convex pattern to the resin material, and the resin material is irradiated with an energy ray through the stamper so that the resin material cures. The stamper is used a plurality of times to repeat these steps a plurality of times, thereby manufacturing a plurality of information recording media.

### BACKGROUND OF THE INVENTION

1. Field of the Invention

The invention relates to a method for manufacturing an information recording medium having a recording layer of concavo-convex pattern, a method of transferring a concavo-convex pattern, and a transfer apparatus for use therein.

2. Description of the Related Art

Conventionally, there has been known a technique for manufacturing an information recording medium that has a recording layer of concavo-convex pattern, such as an optical recording medium. In the technique, an energy-ray curable resin material having the property of absorbing energy rays such as ultraviolet rays for curing is applied to the top of an object to be processed. A light-transmitting stamper having a predetermine concavo-convex pattern formed on its transfer area is brought into contact with the resin material, thereby transferring the concavo-convex pattern to the resin material, and the resin material is irradiated with the energy rays through the stamper so that the resin material cures. Since optical recording media prefer uncolored optical materials, ultraviolet curable resins which cure with ultraviolet rays of invisible region are used. The ultraviolet curable resins, curing with ultraviolet rays of invisible region, are also used for the reason that they can suppress degradation ascribable to sunlight or illuminating light. The light-transmitting stamper may be made of various types of light-transmitting resins, glass, and the like.

For example, an optical recording medium with two or more information layers has a light-transmitting spacer layer between one of its information layers and another. The first information layer is initially formed over a substrate having a concavo-convex pattern. An ultraviolet curable resin material is applied to the top of the same, and the stamper is brought into contact with the resin material, thereby transferring the concavo-convex pattern to the resin material. The resin material is also irradiated with ultraviolet rays through the light-transmitting stamper so that the resin material cures, thereby forming the spacer layer which has concavo-convex patterns on both sides. The second information layer can be formed on this spacer layer to form two information layers of concavo-convex patterns (for example, see Japanese Patent Application Laid-Open No. 2006-40459).

Such a technique of forming a resin layer of concavo-convex pattern by using a light-transmitting stamper is also expected to be utilized for manufacturing a magnetic recording medium under the following circumstances.

Conventionally, magnetic recording media such as a hard disk have improved significantly in areal density through such improvements as miniaturization of magnetic particles and changes of materials for forming recording layers, and improving the precision of head processing. Further improvements in the areal density are also expected in the future.

The improvements to the areal density through the conventional improvement techniques are approaching their limits, however, because of manifesting problems including limitations in head processing, erroneous information recording on tracks adjoining to an intended track due to a spreading recording field, and reproduction crosstalk. As a candidate for magnetic recording media capable of achieving a further improvement in the areal density, there have been proposed discrete track media and patterned media in which recording layers are divided into a large number of recording elements (for example, see Japanese Patent Application Laid-Open No. Hei 9-97419).

For the sake of processing a recording layer into a concavo-convex pattern, it is possible to employ such technologies as ion beam etching (IBE) using Ar or other noble gas, and reactive ion etching (RIE) using CO gas as a reactive gas, with a NH₃ or other nitrogen-containing additive gas.

Specifically, a resin material of concavo-convex pattern is formed over a continuous film of recording layer of an object to be processed, which has a substrate, the recording layer and the like formed over the substrate. Based on this resin material of concavo-convex pattern, the recording layer can be processed into a concavo-convex pattern. Incidentally, it has also been proposed to form one or a plurality of mask layers between the recording layer and the resin material so that the mask layer(s) and the recording layer are processed into a concavo-convex pattern one after another based on the resin material.

The foregoing technique of using a light-transmitting stamper is expected to be utilized for forming the resin material of concavo-convex pattern over the recording layer.

When forming the resin material of concavo-convex pattern by the technique of using a light-transmitting stamper, however, the resin material has often failed to cure sufficiently. To be more specific, when the same stamper is used repeatedly, the resin material tends to be more difficult to cure as the number of times of use of the stamper increases, even with the same irradiation intensity and the same irradiation time of ultraviolet rays. This has produced the problem that the concavo-convex pattern transferred to the resin material can be deformed when releasing the stamper from the resin material. In addition, there has been the problem that the resin material can adhere to the transfer area of the stamper.

### SUMMARY OF THE INVENTION

In view of the foregoing problems, various exemplary embodiments of this invention provide a method for manufacturing an information recording medium, a method for transferring a concavo-convex pattern, and a transfer apparatus which are capable of curing a resin material with reliability even when using a light-transmitting stamper repeatedly.

To achieve the foregoing object, various exemplary embodiments of the present invention provide a method including the steps of: inspecting a stamper made of a light-transmitting resin, having a predetermined concavo-convex pattern formed on a transfer area thereof, for an optical characteristic; and bringing the stamper into contact with an energy-ray curable resin material applied to an object to be processed, thereby transferring the concavo-convex pattern to the resin material, and irradiating the resin material with an energy ray through the stamper so that the resin material cures. Here, the stamper is used a plurality of times to repeat these steps a plurality of times, thereby manufacturing a plurality of information recording media.

To achieve the foregoing object, various exemplary embodiments of the present invention also provide a method including the steps of: checking the number of times of use of a stamper made of a light-transmitting resin, having a predetermined concavo-convex pattern formed on a transfer area thereof; and bringing the stamper into contact with an energy-ray curable resin material applied to an object to be processed, thereby transferring the concavo-convex pattern to the resin material, and irradiating the resin material with an energy ray through the stamper so that the resin material cures. Here, the stamper is used a plurality of times to repeat these steps a plurality of times, thereby manufacturing a plurality of information recording media. The amount of irradiation of the energy ray to irradiate the resin material with is controlled in the step of transferring, based on the number of times of use of the stamper.

To achieve the foregoing object, various exemplary embodiments of the present invention also provide a transfer apparatus including: an irradiator capable of irradiating an object to be transferred with a predetermined energy ray through a stamper made of a light-transmitting resin, having a predetermined concavo-convex pattern formed on a transfer area thereof; an inspection instrument capable of inspecting the stamper for an optical characteristic; and a controller capable of controlling the amount of irradiation of the irradiator based on the optical characteristic of the stamper.

In the process of conceiving the present invention, the inventors have made intensive studies on the reason why the repeated use of the same stamper makes the resin material more difficult to cure as the number of times of use of the stamper increases, even with the same irradiation intensity and the same irradiation time of ultraviolet rays. Then, they have found that the irradiation of the ultraviolet rays degrades the stamper with a gradual decrease in transmittance as shown in FIG. 16. That is, it has been found out that the irradiated ultraviolet rays gradually increase in the proportion to be absorbed by the stamper and gradually decrease in the proportion to reach the resin material, which makes it less easy for the resin material to cure. This is particularly noticeable when the stamper is made of a resin material.

It should be noted that the foregoing problems can be solved by replacing the stamper before degradation, using each stamper only once or several times, whereas this produces the problem of increased production cost.

Stamper degradation hardly occurs if the stamper is made of glass. Glass stampers, however, have the problem of significantly low production efficiency as compared to resin stampers.

In view of this, the stamper may be inspected for optical characteristics, and the amount of irradiation of the energy rays to irradiate the resin material with may be controlled in the transfer step, based on the result of inspection on the optical characteristics of the stamper. This can cure the resin material with reliability even if the stamper is degraded through repeated use and gradually becomes less transparent to the energy rays such as ultraviolet rays.

The resin material can also be cured with reliability if the amount of irradiation of the energy ray to irradiate the resin material with is controlled in the transfer step, based on the number of times of use of the stamper.

In addition, the use limit of the stamper may be distinguished based on the result of inspection on the optical characteristics of the stamper.

Based on the result of inspection on the optical characteristics of the stamper, the presence or absence of the resin material adhering to the stamper may also be distinguished to check if the resin material is successfully formed in a desired concavo-convex pattern.

Accordingly, various exemplary embodiments of this invention provide a method for manufacturing an information recording medium, comprising: an inspection step of inspecting a stamper made of a light-transmitting resin, having a predetermined concavo-convex pattern formed on a transfer area thereof, for an optical characteristic; and a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein the stamper is used a plurality of times to repeat the steps a plurality of times, thereby manufacturing a plurality of information recording media.

Moreover, various exemplary embodiments of this invention provide a method for manufacturing an information recording medium, comprising: a use number checking step of checking the number of times of use of a stamper made of a light-transmitting resin, having a predetermined concavo-convex pattern formed on a transfer area thereof; and a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein the stamper is used a plurality of times to repeat these steps a plurality of times, thereby manufacturing a plurality of information recording media, and an amount of irradiation of the energy ray to irradiate the resin material with is controlled in the transfer step, based on the number of times of use of the stamper.

Various exemplary embodiments of this invention provide a method for transferring a concave-convex pattern, comprising: an inspection step of inspecting a stamper made of a light-transmitting resin, having a predetermined concavo-convex pattern formed on a transfer area thereof, for an optical characteristic; and a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein the stamper is used a plurality of times to repeat the steps a plurality of times.

Moreover, various exemplary embodiments of this invention provide a method for transferring a concave-convex pattern, comprising: a use number checking step of checking the number of times of use of a stamper made of a light-transmitting resin, having a predetermined concavo-convex pattern formed on a transfer area thereof; and a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein the stamper is used a plurality of times to repeat these steps a plurality of time, and an amount of irradiation of the energy ray to irradiate the resin material with is controlled in the transfer step, based on the number of times of use of the stamper.

Furthermore, various exemplary embodiments of this invention provide a transfer apparatus comprising: an irradiator capable of irradiating an object to be transferred with a predetermined energy ray through a stamper made of a light-transmitting resin, having a predetermined concavo-convex pattern formed on a transfer area thereof; an inspection instrument capable of inspecting the stamper for an optical characteristic; and a controller capable of controlling an amount of irradiation of the irradiator based on the optical characteristic of the stamper.

As employed in the description of the present patent application, the term “wavelength distribution characteristic” refers to a characteristic that shows the relationship between the wavelength and the amount of irradiation per unit time, or corresponding relative irradiation intensity, of the energy rays.

Furthermore, the term “absorption characteristic,” as employed in the description of the present patent application, refers to a characteristic that shows the relationship between the wavelength of the energy rays and the rate of relative absorption, or corresponding absorbance, of the energy rays by the resin material (the object to be transferred).

### BRIEF DESCRIPTION OF THE DRAWINGS

FIG. 1 is a radial sectional view schematically showing the structure of the starter of an object to be processed in the steps for manufacturing a magnetic recording medium according to a first exemplary embodiment of the present invention;

FIG. 2 is a radial sectional view schematically showing the structure of a magnetic recording medium that is obtained by processing the object to be processed;

FIG. 3 is a flowchart showing an outline of the steps for manufacturing the magnetic recording medium;

FIG. 4 is a radial sectional view schematically showing the step of applying a resin material to the object mentioned above;

FIG. 5 is a graph showing the absorption characteristic of the resin material;

FIG. 6 is a partially-sectional side view schematically showing a stamper and a transfer apparatus according to the first exemplary embodiment;

FIG. 7 is a graph showing the wavelength distribution characteristic of an irradiator in the transfer apparatus;

FIG. 8 is a graph showing an example of the result of inspection on optical characteristics of the stamper;

FIG. 9 is a partially-sectional side view schematically showing the step of transferring a concavo-convex pattern to the resin material by using the stamper;

FIG. 10 is a radial sectional view schematically showing the configuration of the object to be processed in which the recording layer is processed into a concavo-convex pattern;

FIG. 11 is a radial sectional view schematically showing the configuration of the object in which a filler is deposited over the recording layer;

FIG. 12 is a radial sectional view schematically showing the configuration of the object to be processed in which the surfaces of recording elements and the filler are flattened;

FIG. 13 is a flowchart showing an outline of the steps for manufacturing a magnetic recording medium according to a second exemplary embodiment of the present invention;

FIG. 14 is a flowchart showing an outline of the steps for manufacturing a magnetic recording medium according to a third exemplary embodiment of the present invention;

FIG. 15 is a flowchart showing an outline of the steps for manufacturing a magnetic recording medium according to a fourth exemplary embodiment of the present invention; and

FIG. 16 is a graph showing the relationship between the number of times of use and the transmittance of a stamper according to a working example of the present invention.

### DETAILED DESCRIPTION OF THE PREFERRED EMBODIMENTS

Hereinafter, preferred exemplary embodiments of the present invention will be described in detail with reference to the drawings.

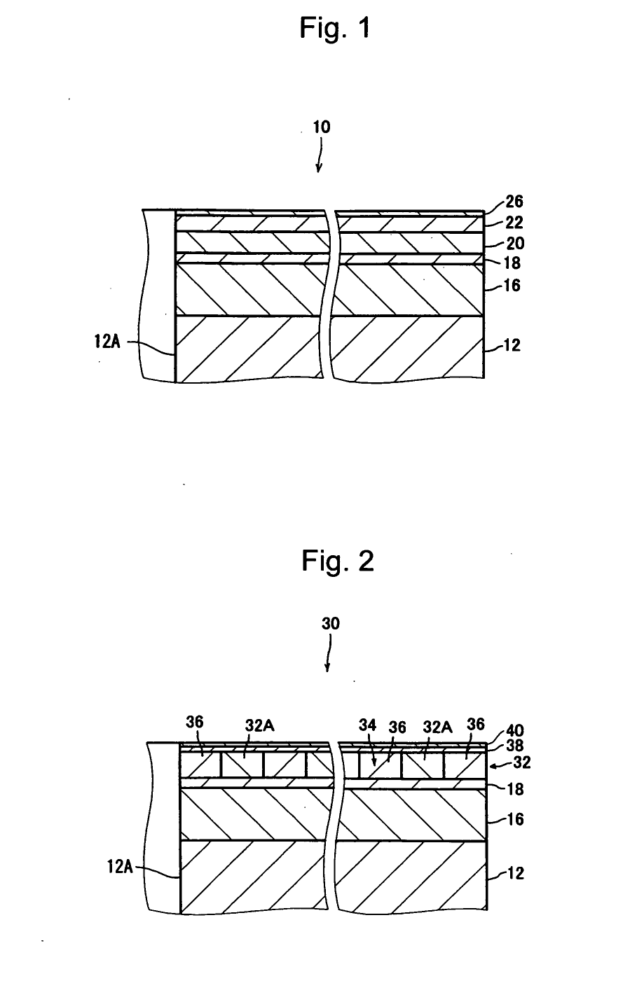

A first exemplary embodiment of the present invention relates to a method for manufacturing a magnetic recording medium (information recording medium), where such processing as dry etching is applied to a starting body of an object to be processed 10 shown in FIG. 1 so that a recording layer of a continuous film is processed into a predetermined line-and-space pattern (data track pattern) such as shown in FIG. 2 and a servo pattern (not shown). This method is characterized by the steps of inspecting a stamper made of a light-transmitting resin, and using this stamper to transfer a concavo-convex pattern to a resin material for processing the recording layer into a concavo-convex pattern. The rest of the configuration is not particularly important to understand this first exemplary embodiment, and the description thereof will thus be omitted where appropriate.

As shown in FIG. 1, the starting body of the object to be processed 10 includes a substrate 12, a soft magnetic layer 16, a seed layer 18, a recording layer 20 of a continuous film, a first mask layer 22, and a second mask layer 26. These layers are formed over the substrate 12 in this order.

The substrate 12 has a generally disk-like shape with a center hole 12A. The substrate 12 may be made of such materials as glass, Al and Al₂O₃.

The soft magnetic layer 16 has a thickness of 50 to 300 nm. The soft magnetic layer 16 may be made of such materials as an Fe alloy and a Co alloy.

The seed layer 18 has a thickness of 2 to 40 nm. The seed layer 18 may be made of such materials as a nonmagnetic CoCr alloy, Ti, Ru, a Ru—Ta laminate, and MgO.

The recording layer 20 has a thickness of 5 to 30 nm. The recording layer 20 may be made of such materials as a CoCr alloy including a CoCrPt alloy, an FePt alloy, a laminate of these, and material in which CoPt or other ferromagnetic particles are contained in a matrix such as SiO₂ or other oxide materials.

The first mask layer 22 has a thickness of 3 to 50 nm. The first mask layer 22 may be made of C (carbon). For example, a hard carbon film called diamond like carbon (hereinafter, referred to as “DLC”) may be used as the material of the first mask layer 22.

The second mask layer 26 has a thickness of 2 to 30 nm. The second mask layer 26 may be made of such materials as Ni, Cu, Cr, Al, Al₂O₃, and Ta.

The magnetic recording medium 30 is a discrete track medium of perpendicular recording type, having a disk-like shape. In a data area, a recording layer 32 is formed to have a concavo-convex pattern formed by dividing the continuous recording layer 20 into a large number of concentric arc-shaped recording elements 32A arranged at small intervals in the radial direction. FIG. 2 shows this shape. In a servo area, the recording layer 32 is divided into a large number of recording elements in a predetermined servo pattern (not shown). A filler 36 is filled into concave portions 34 between the recording elements 32A. A protective layer 38 and a lubricating layer 40 are formed in this order over the recording elements 32A and the filler 36.

The filler 36 may be made of such materials as SiO₂, C (carbon), DLC, and resin materials. The protective layer 38 has a thickness of 1 to 5 nm. The protective layer 38 may be made of DLC. The lubricating layer 40 has a thickness of 1 to 2 nm. The protective layer 40 may be made of PFPE (perfluoropolyether).

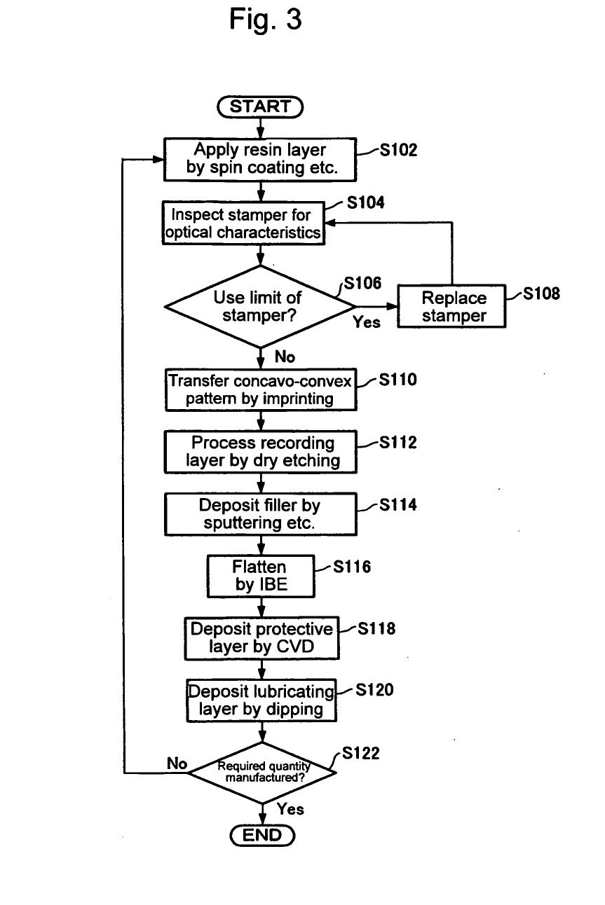

Now, the method for manufacturing the magnetic recording medium 30 will be described with reference to the flowchart shown in FIG. 3 and other drawings.

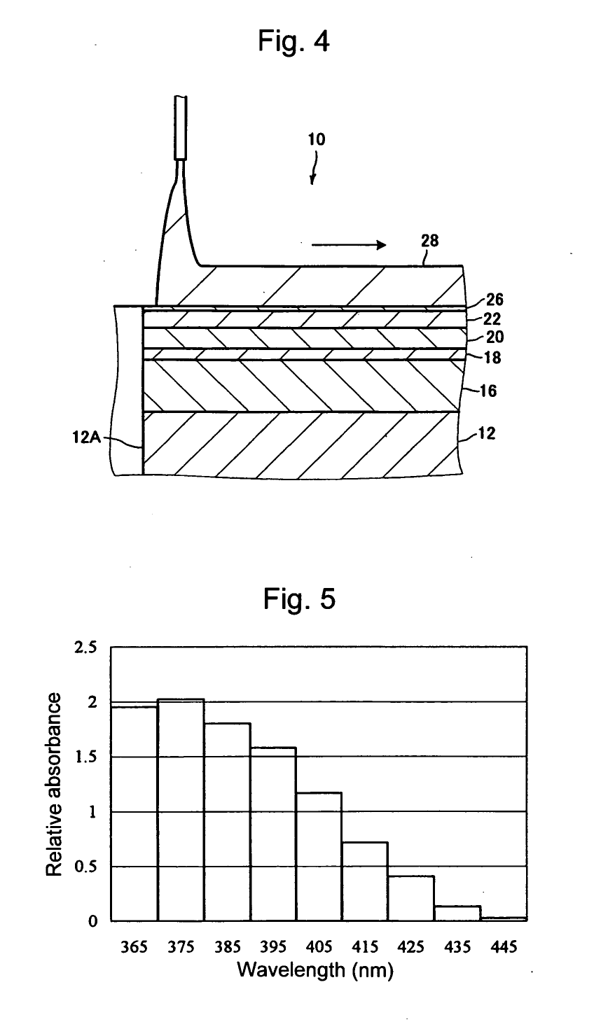

Initially, as shown in FIG. 4, an energy-ray curable resin material 28 is applied to a thickness of 30 to 300 nm on the second mask layer 26 of the starting body of the object to be processed 10, by spin coating (S102). Specifically, a predetermined amount of resin material 28 is fed to the periphery of the center hole 12A, and the object 10 is rotated so that the resin material 28 is spread over the second mask layer 26 by the centrifugal force. It should be noted that the resin material 28 may be applied onto the second mask layer 26 by dipping.

The resin material 28 may be an energy-ray curable resin material having the characteristic of absorbing energy rays such as ultraviolet rays, visible light, or the like for curing.

Specifically, resin materials available include various types of monomers and oligomers containing a photopolymerization initiator additive that has the characteristic of absorbing ultraviolet rays or visible light for activation (excitation), thereby initiating the polymerization reaction of these monomers and oligomers.

The resin materials available also include various types of monomers and oligomers containing a photopolymerization initiator additive that has the characteristic of initialing the polymerization reaction of the monomers and oligomers, along with a sensitizer that has the characteristic of absorbing ultraviolet rays or visible light and activating (exciting) the photopolymerization initiator.

Among examples of the monomers and oligomers available are acrylic monomers and oligomers. More specifically, the acrylic resins available can be obtained by blending oligomers of urethane acrylate, epoxy acrylate, silicone acrylate, or polyester acrylate with monomers of trimethylolpropane triacrylate, pentaerythritol triacrylate, hexanediol diacrylate, hydroxyphenoxy propyl acrylate, or the like having one to three functional groups, in consideration of desired physical properties (curing property, viscosity, curing contraction, and adhesiveness).

Among the specific examples of the photopolymerization initiator is IRGACURE™ 819 (from Ciba Specialty Chemicals). FIG. 5 is a graph showing the absorption characteristic of a resin material that contains IRGACURE 819.

The starting body of the object to be processed 10 is obtained by forming the soft magnetic layer 16, the seed layer 18, the continuous film of recording layer 20, the first mask layer 22, and the second mask layer 26 on the substrate 12 in this order. The first mask layer 22, if made of DLC, is formed by CVD. The soft magnetic layer 16 may be formed by plating.

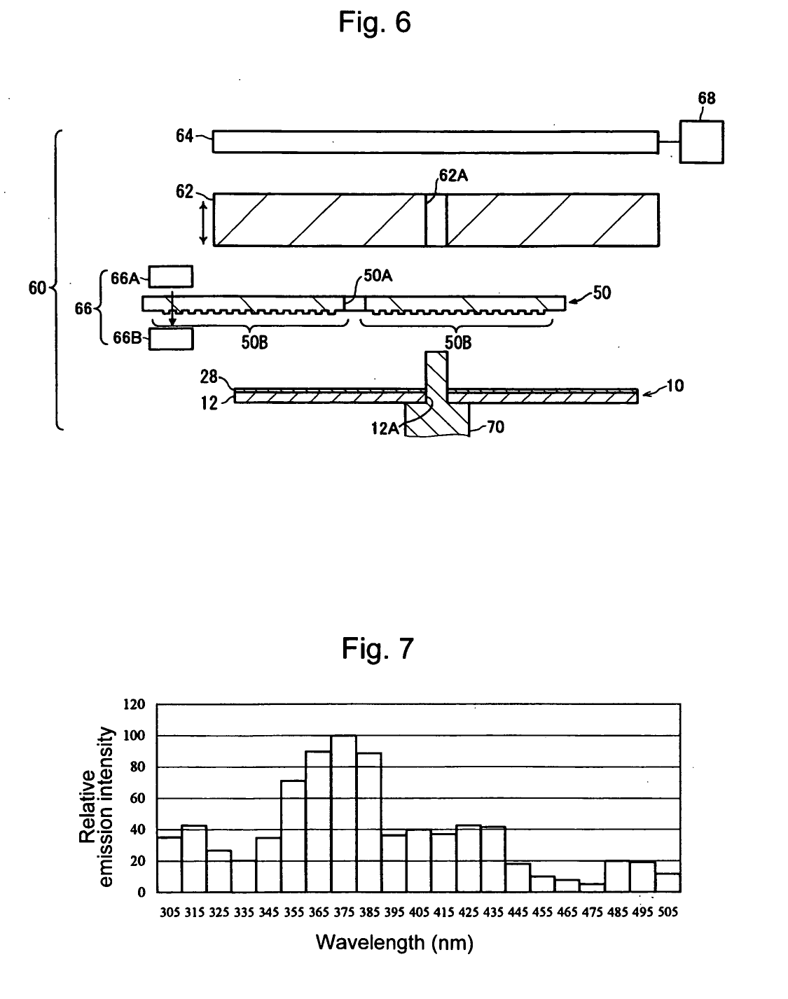

Next, a stamper 50 made of a light-transmitting resin, such as shown in FIG. 6, is inspected for optical characteristics (S104).

The stamper 50 has a generally disk-like shape with a center hole 50A, and has a transfer area 50B on which a concavo-convex pattern corresponding to the concavo-convex pattern of the recording layer 20 is formed. The stamper 50 may be made of light-transmitting resins such as polymethylmethacrylate, polyolefin, and polycarbonate. The stamper 50 is loaded into a transfer apparatus 60 for use.

The transfer apparatus 60 includes: a stamper stage 62 which is capable of applying pressure to the resin material (object to be transferred) 28 through the stamper 50; an irradiator 64 which is capable of irradiating the resin material 28 with energy rays such as ultraviolet rays and visible light through the stamper 50; an inspection instrument 66 which is capable of inspecting the stamper for optical characteristics; and a controller 68 which is capable of controlling the amount of irradiation of the irradiator 64 based on the optical characteristics of the stamper 50.

The stamper stage 62 has a generally disk-like shape with a center hole 62A. The stamper stage 62 may be made of glass. The stamper stage 62 can be moved up and down by a not-shown drive unit.

Examples of the irradiator 64 include a metal halide lamp, a high-pressure mercury lamp, and a diode and a semiconductor laser that can emit laser light having a wavelength in the ultraviolet or visible region. The irradiator 64 is arranged above the stamper stage 62. FIG. 7 is a graph showing an example of the wavelength distribution characteristic of a metal halide lamp.

The inspection instrument 66 can measure data from which the irradiation intensity of the energy rays transmitted through the stamper 50 in the transfer step (S110) can be predicted. More specifically, the inspection instrument 66 includes a projector 66A and a photoreceiver 66B. It can measure, for example, the irradiation intensities of respective wavelength components of the energy rays with which the projector 66A irradiates the photoreceiver 66B directly, and the irradiation intensities of the respective wavelength components of the energy rays with which the projector 66A irradiates the photoreceiver 66B through the stamper 50. The product obtained by multiplying the transmittances of the stamper 50 to the respective wavelength components (of the energy rays), that is the ratios of the irradiation intensities of these respective wavelength components, by the irradiation intensities of the respective wavelength components of the energy rays that are emitted from the irradiator 64 and yet to reach the stamper 50 is predicted to be the irradiation intensities of the respective wavelength components of the energy rays that are emitted from the irradiator 64 and transmitted through the stamper 50 in the transfer step (S110). Moreover, the wavelength distribution characteristic of the energy rays that are emitted from the irradiator 64 and transmitted through the stamper 50 in the transfer step (S110) can be predicted by multiplying the wavelength distribution characteristic of the energy rays that are emitted from the irradiator 64 and yet to reach the stamper 50 by the transmittances of the stamper 50 to the respective wavelength components. Note that the irradiation intensities of the respective wavelength components of the energy rays with which the projector 66A irradiates the photoreceiver 66B directly need not necessarily be measured each time. For example, the measurement may be made only for the first time, or may be made in advance before starting the manufacturing operation. The measurement may also be made once for several times of use.

The controller 68 is a personal computer, a microcomputer, or the like which is capable of calculating the irradiation intensities and the wavelength distribution characteristic of the energy rays that are emitted from the irradiator 64 and transmitted through the stamper 50 in the transfer step (S110), based on the data measured by the inspection instrument 66. The controller 68 can control the amount of irradiation of the energy rays, based on the calculations of the irradiation intensities and the wavelength distribution characteristic of the energy rays transmitted through the stamper in the transfer step (S110), and the absorption characteristic and the like of the resin material 28.

The transfer apparatus 60 further includes a retainer 70 which can fit into the center hole 12A of the object to be processed 10 and retain the object 10. The retainer 70 is also configured to fit into the center hole 50A of the stamper 50 and the center hole 62A of the stamper stage 62, thereby positioning these object to be processed 10, stamper 50, and stamper stage 62 for center alignment.

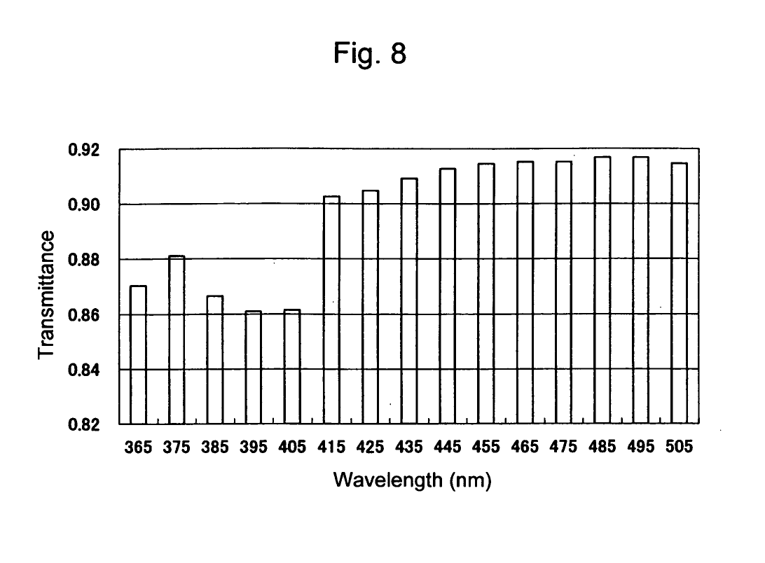

The inspection instrument 66 measures the stamper 50 for optical characteristics such as transmittance. FIG. 8 shows an example of the transmittance characteristic obtained. As employed in the description of the present patent application, the term “transmittance characteristic” refers to a characteristic that shows the relationship between the wavelength of the energy rays and the transmittance of the stamper.

Next, based on the result of inspection on the optical characteristics of the stamper 50, the use limit of the stamper 50 is distinguished (S106). For example, if the irradiation intensities of the energy rays transmitted through the stamper 50, measured in the inspection step (S104), reach or exceed a predetermined reference value, or if the transmittance of the stamper to a predetermined wavelength reaches or exceeds a predetermined reference value, then the stamper 50 is distinguished to be usable. On the other hand, if the irradiation intensities of the energy rays transmitted through the stamper 50, measured in the inspection step (S104), fall below a predetermined reference value, or if the transmittance of the stamper to a predetermined wavelength falls below a predetermined reference value, then the stamper 50 is distinguished to be unusable.

If the stamper 50 is yet to reach its use limit and is distinguished to be usable, the processing proceeds to the next transfer step (S110). The same stamper 50 is used in the transfer step (S110).

If the stamper 50 has reached its use limit and is distinguished to be unusable, on the other hand, the stamper 50 is replaced with another stamper 50 (S108). The replacing stamper 50 is also inspected for optical characteristics (S104), and the processing proceeds to the next transfer step (S110) only if the stamper 50 is distinguished to be usable (S106).

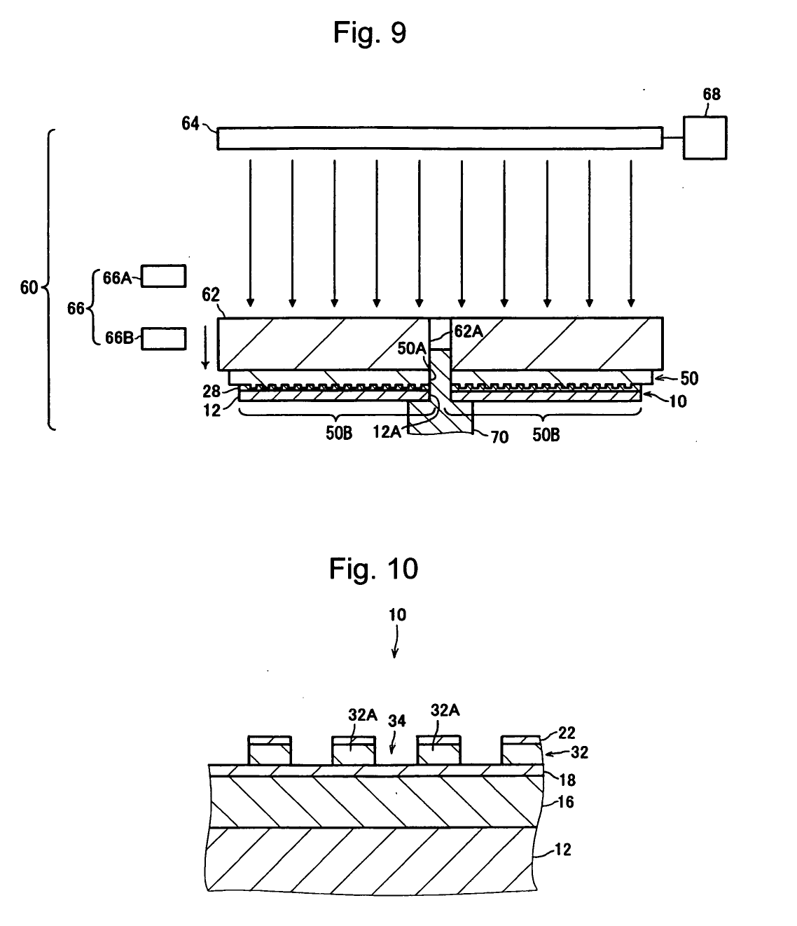

In the transfer step (S110), as shown in FIG. 9, the stamper 50 and the transfer apparatus 60 are used to transfer the concavo-convex pattern to the resin material 28 by imprinting. Specifically, the stamper 50 is placed on the object to be processed 10 which is retained by the retainer 70, so that the transfer area 50B comes into contact with the resin material 28. The stamper stage 62 is then lowered to apply pressure to the resin material 28 through the stamper 50, thereby transferring the concavo-convex pattern to the resin material 28. In the meantime, the irradiator 64 irradiates the resin material 28 with energy rays such as ultraviolet rays and visible light through the stamper stage 62 and the stamper 50. The resin material 28 increases in molecular weight through polymerization and cross-linking reactions, curing to turn into a solid state. Note that the arrows under the irradiator 64 in FIG. 9 schematically show the direction of irradiation of the energy rays. In FIGS. 6 and 9, the layers of the object to be processed 10 between the substrate 12 and the resin material 28 are omitted.

Here, the amount of irradiation of the energy rays to irradiate the resin material 28 with is controlled based on the result of inspection on the optical characteristics of the stamper 50 in the inspection step (S104).

For example, the irradiation intensities of the energy rays that are emitted from the irradiator 64 and are transmitted through the stamper 50 in the transfer step (S110) are predicted from the data measured in the inspection step (S104). The irradiator 64 is then controlled based on the predicted irradiation intensities of the energy rays transmitted through the stamper in the transfer step (S110) and the absorption characteristic of the resin material 28. More specifically, the wavelength distribution characteristic of the energy rays transmitted through the stamper 50 in the transfer step (S110) can be predicted from the wavelength distribution characteristic of the energy rays that are emitted from the irradiator 64 and yet to be transmitted through the stamper 50 and the transmittance characteristic of the stamper 50, such as shown in FIGS. 7 and 8. Based on this predicted wavelength distribution characteristic of the energy rays transmitted through the stamper 50 in the transfer step (S110) and the absorption characteristic of the resin material 28 such as shown in FIG. 5, curing coefficients are calculated for the respective wavelength components of the energy rays. Here, the curing coefficients are equivalent to the products obtained by multiplying the amounts of irradiation per unit time of the energy rays transmitted through the stamper 50 in the transfer step (S110), or relative irradiation intensities corresponding thereto, by the rates of relative absorption of the resin material 28 to the energy rays, or relative absorbances corresponding thereto. These curing coefficients are then summed into an integrated curing coefficient. It is considered that the greater value the integrated curing coefficient has, the higher energy the resin material absorbs to promote curing. Incidentally, the irradiation intensities and the wavelength distribution characteristic of the energy rays that are emitted from the irradiator 64 and yet to be transmitted through the stamper 50 are measured in advance by experiment or other means. A reference integrated curing coefficient, which is the integrated curing coefficient for the case where the resin material 28 is irradiated with the energy rays directly without the intervention of the stamper 50, i.e., when the stamper 50 has a transmittance of 1.0 to all the wavelength components of the energy rays, is also calculated in advance. The reference amount of irradiation, or the amount of irradiation appropriate for curing the resin material 28 sufficiently when the irradiator 64 irradiates the resin material 28 of the object to be processed 10 with the energy rays directly without the intervention of the stamper 50, is also measured in advance by experiment or other means.

The irradiator 64 is controlled so that the amount of irradiation of the energy rays emitted from the irradiator 64 exceeds the reference amount of irradiation in proportion to the ratio obtained by dividing the reference integrated curing coefficient by the integrated curing coefficient that is calculated from the data measured in the inspection step (S104) and the absorption characteristic of the resin material 28. Specifically, either one or both of the irradiation time of the energy rays and the output power of the irradiator are controlled.

As above, the amount of irradiation of the energy rays to irradiate the resin material 28 with is controlled in the transfer step (S110), based on the result of inspection on the optical characteristics of the stamper 50 in the inspection step (S104). This makes it possible to cure the resin material 28 with reliability even if the stamper 50 is degraded through repeated use and gradually becomes less transparent to the energy rays such as ultraviolet rays.

When the resin material 28 is cured, the stamper stage 62 is separated from the stamper 50. The stamper 50 is then released from the resin material 28 of the object to be processed 10.

Next, as shown in FIG. 10, the recording layer 20 is processed into a concavo-convex pattern by dry etching based on the resin material 28 of concavo-convex pattern (S112). More specifically, portions of the resin material 28 lying under the concave portions are initially removed by RIE, using an oxygen-based gas. Convex portions of the resin material 28 are also removed from partially, whereas the convex portions remain as much as the difference in level between the transferred concave portions and convex portions. Next, portions of the second mask layer 26 lying under the concave portions are removed based on the resin material 28 of concavo-convex pattern by IBE, using a noble gas such as Ar, Kr, and Xe. Portions of the first mask layer 22 lying under the concave portions are then removed by RIE, using a halogen-based gas, for example. Moreover, portions of the recording layer 20 of continuous film lying under the concave portions are removed by IBE, using a noble gas such as Ar. This divides the recording layer 20 of continuous film into a large number of recording elements 32A, forming the recording layer 32 of concavo-convex pattern. At this point of time, most of the resin material 28 and the second mask layer 26 over the recording elements 32A are removed. The first mask layer 22 remaining on the recording elements 32A is completely removed by RIE, using an oxygen-based gas, a halogen-based gas, or a hydrogen-based gas such as NH₃ and H₂, for example.

Next, as shown in FIG. 11, the filler 36 is deposited over the recording layer 32 of concavo-convex pattern by sputtering or bias sputtering, so that the concave portions 34 between the recording elements 32A are filled with the filler 36 (S114). The filler 36, if made of a resin material, is deposited by spin coating.

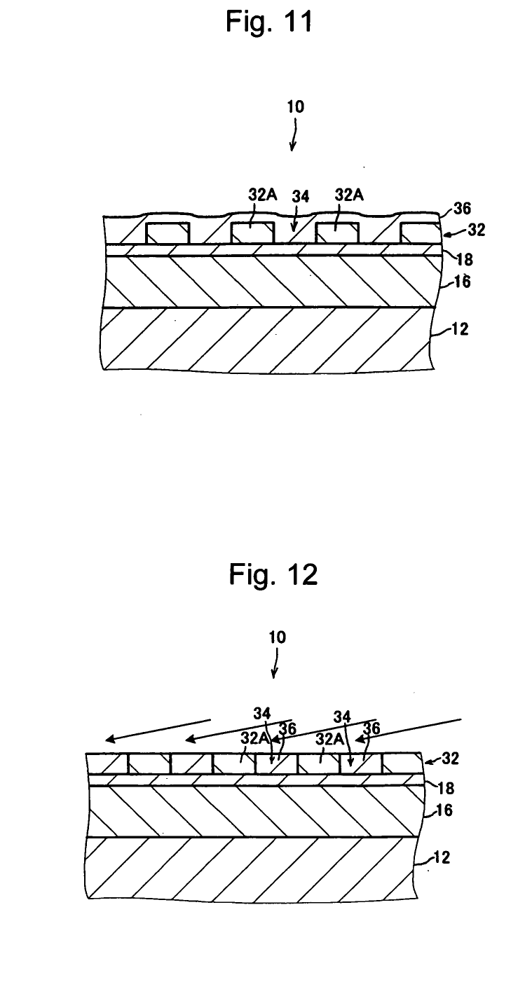

Next, as shown in FIG. 12, the portions of the filler 36 lying above (on the side opposite from the substrate 12) the top of the recording elements 32A are removed by IBE using a noble gas such as Ar. This flattens the surfaces of the recording elements 32A and the filler 36 (S116). It should be noted that the arrows in FIG. 12 schematically show the direction of irradiation of the processing gas.

Next, the protective layer 38 is formed over the recording elements 32A and the filler 36 by CVD (S118).

Furthermore, the lubricating layer 40 is applied onto the protective layer 38 by dipping (S120). This completes the magnetic recording medium 30 shown in FIG. 2 seen above.

Whether or not a required number of magnetic recording media 30 are manufactured is determined here (S122). If the required number of magnetic recording media 30 are yet to be manufactured, the foregoing steps are repeated. If the required number of magnetic recording media 30 are manufactured, the manufacturing operation is ended.

Next, a description will be given of a second exemplary embodiment of the present invention.

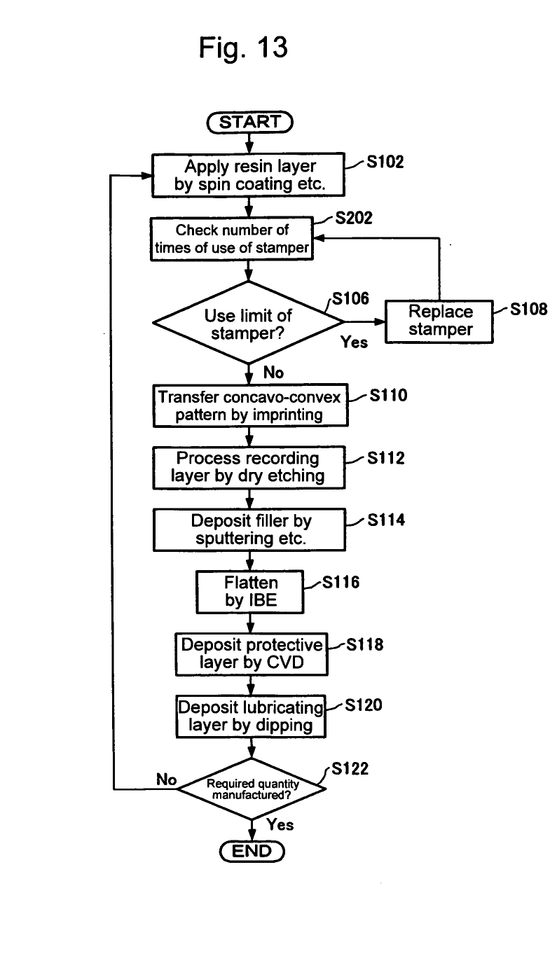

In the foregoing first exemplary embodiment, the optical characteristics of the stamper 50 are inspected in the inspection step (S104). The use limit of the stamper 50 is then distinguished (S106), and the amount of irradiation of the energy rays in the transfer step (S110) is controlled based on the result of inspection on the optical characteristics of the stamper 50. According to this second exemplary embodiment, as shown in the flowchart of FIG. 13, a use number checking step (S202) for checking the number of times of use of the stamper 50 is provided instead of the inspection step (S104). Then, based on the number of times of use of the stamper 50, the use limit of the stamper 50 is distinguished (S106), and the amount of irradiation of the energy rays in the transfer step (S110) is controlled.

In other respects, the second exemplary embodiment is the same as the foregoing first exemplary embodiment. The same reference numerals as in FIGS. 1 to 12 will thus be employed for like parts, and descriptions thereof will be omitted as appropriate.

For example, the relationship between the number of times of use of the stamper 50 and the optical characteristics of the stamper 50 can be grasped by performing the foregoing first exemplary embodiment.

Therefore, it is possible to predict a change in the optical characteristics of the stamper 50 based on the number of times of use of the stamper 50 without actually inspecting the stamper 50 for the optical characteristics. Based on the predicted optical characteristics of the stamper 50, the amount of irradiation of the irradiator 64 can be controlled, for example, so as to compensate a drop in the transmittance of the stamper 50. As above, even when the amount of irradiation of the energy rays to irradiate the resin material 28 with is controlled based on the number of times of use of the stamper 50, it is possible to cure the resin material 28 with reliability no matter if the stamper 50 is degraded through repeated use and gradually becomes less transparent to the energy rays such as ultraviolet rays.

The use limit of the stamper 50 can also be distinguished from the predicted optical characteristics of the stamper 50.

Next, a description will be given of a third exemplary embodiment of the present invention.

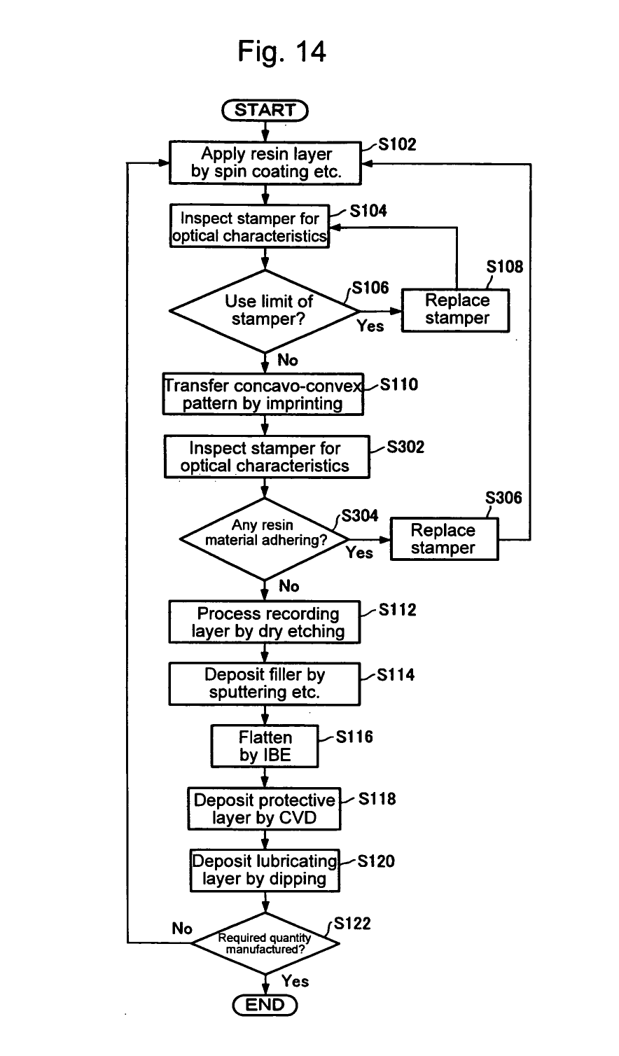

In the foregoing first exemplary embodiment, the inspection step (S104) is provided only before the transfer step (S110). According to this third exemplary embodiment, as shown in the flowchart of FIG. 14, an inspection step (S302) is also provided after the transfer step (S110). Then, this inspection step (S302) is followed by an adhering resin material distinction step (S304) and a stamper replacement step (S306).

In other respects, the third exemplary embodiment is the same as the foregoing first exemplary embodiment. The same reference numerals as in FIGS. 1 to 12 will thus be employed for like parts, and descriptions thereof will be omitted as appropriate.

In the adhering resin material distinction step (S304), the presence or absence of the resin material 28 adhering to the stamper 50 is distinguished based on the result of inspection on the optical characteristics of the stamper 50 in the inspection step (S302). For example, in the inspection step (S302), the stamper 50 is irradiated with laser light and the irradiating position is radially moved back and forth while the stamper 50 is rotated and measured for transmittance. This obtains the transmittances at various locations of the stamper 50. If it is detected that one location has a different transmittance than others, then this location is determined to have the resin material 28 adhering. Incidentally, various types of energy rays may be used instead of the laser light as long as the range of irradiation can be limited to some extent.

If the stamper 50 is distinguished to have no resin material 28 adhering, the processing proceeds to the next recording layer processing step (S112).

If the stamper 50 is distinguished to have the resin material 28 adhering, on the other hand, this object to be processed 10 is rejected from the manufacturing line. The stamper 50 is then replaced with another stamper 50 (S306), and the processing returns to the resin material application step (S102) to process another object to be processed 10.

As above, the resin material 28 adhering to the stamper 50 can be detected to find a transfer failure in the transfer step (S110) at an early stage, which contributes to improved production efficiency and quality.

It should be noted the use number checking step (S202) may be provided before the transfer step (S110) as in the foregoing second exemplary embodiment, instead of the inspection step (S104), so that the use limit of the stamper 50 is distinguished (S106) and the amount of irradiation of the energy rays in the transfer step (S110) is controlled based on the number of times of use of the stamper 50.

Next, a description will be given of a fourth exemplary embodiment of the present invention.

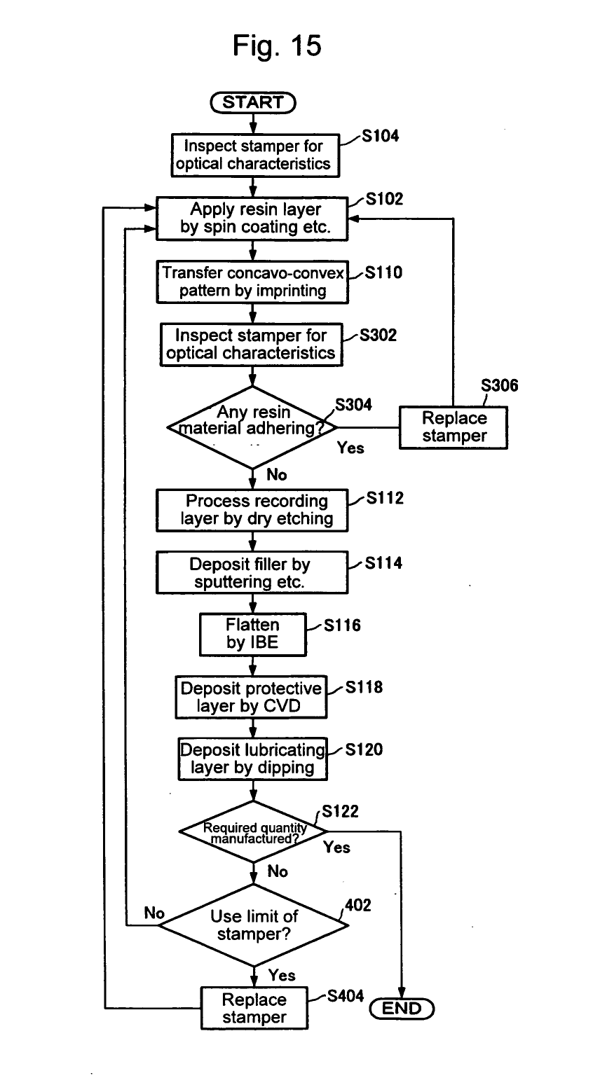

In the foregoing third exemplary embodiment, the inspection step (S104) is performed before the transfer step (S110) each time. According to this fourth exemplary embodiment, as shown in the flowchart of FIG. 15, the inspection step (S104) is performed before the transfer step (S110) only when the stamper 50 is used for the first time. In addition, a use limit distinction step (S402) and a stamper replacement step (S404) are provided after the manufactured number determination step (S122).

In other respects, the forth exemplary embodiment is the same as the foregoing third exemplary embodiment. The same reference numerals as in FIGS. 1 to 12 and 14 will thus be employed for like parts, and descriptions thereof will be omitted as appropriate.

In the transfer step (S110), the amount of irradiation of the energy rays to irradiate the resin material 28 with is controlled based on the result of inspection of the inspection step (S104) which is performed before the transfer step (S110), only when the stamper 50 is used for the first time. At the second and subsequent times of use, the amount of irradiation of the energy rays to irradiate the resin material 28 with is controlled based on the result of inspection on the optical characteristics of the stamper 50 in the inspection step (S302) of the preceding time. Based on the result of inspection on the optical characteristics of the stamper 50 in the inspection step (S302), the use limit of the stamper 50 is distinguished in the use limit distinction step (S402). More specifically, according to this fourth exemplary embodiment, the inspection step (S302) includes measuring: data for distinguishing the presence or absence of the resin material 28 adhering to the stamper 50 in the previous transfer step (S110); data for distinguishing the use limit of the stamper 50 in the use limit distinction step (S402); and data for controlling the amount of irradiation of the energy rays in the transfer step (S110) of next time.

As above, the amount of irradiation of the energy rays to irradiate the resin material 28 with is controlled based on the result of inspection on the optical characteristics of the stamper 50 in the inspection step (S302) of the preceding time. This requires only that the inspection step (S104) be performed before the transfer step (S110) only when the stamper 50 is used for the first time, contributing to improved production efficiency since the inspection step (S104) before the transfer step (S110) can be omitted for the second and subsequent times of use. Incidentally, the appropriate amount of irradiation of the energy rays capable of fully curing the resin material 28 when using the stamper 50 for the first time may be determined in advance by experiment or other means. Then, the amount of irradiation of the energy rays to irradiate the resin material 28 with is so controlled in the first transfer step (S110). This makes it possible to omit the inspection step (S104) even for the first time.

The foregoing third and fourth exemplary embodiments have dealt with the cases where the inspection step (S302) is performed after the transfer step (S110), and is followed by the adhering resin material distinction step (S304) in which the presence or absence of the resin material 28 adhering to the stamper in the transfer step (S110) is distinguished based on the result of inspection on the optical characteristics of the stamper 50 in the inspection step (S302). Nevertheless, the adhering resin material distinction step may be provided, for example, between the inspection step (S104), which is performed before the transfer step (S110), and the transfer step (S110). Then, the presence or absence of the resin material 28 adhering to the stamper 50 in the transfer step (S110) of the preceding time, that is performed before the inspection step (S104), may be distinguished based on the result of inspection on the optical characteristics of the stamper 50 in the inspection step (S104).

Moreover, the inspection step (S104) of the foregoing first exemplary embodiment has dealt with the case where the stamper 50 is measured for transmittance characteristics even across wavelength ranges such as shown in FIG. 8 where absorption is negligible as far as the absorption characteristic of the resin material 28 shown in FIG. 5 is concerned. Nevertheless, the wavelength ranges where absorption is negligible may be excluded when measuring the transmittance characteristic of the stamper 50, so that the amount of irradiation of the energy rays to be emitted from the irradiator 64 in the transfer step (S110) may be controlled based on this transmittance characteristic.

The first, third, and fourth exemplary embodiments have dealt with the cases where the inspection steps (S104) and (S302) include measuring the data from which the irradiation intensities of various wavelength components of the energy rays transmitted through the stamper 50 in the transfer step (S110) can be predicted. The amount of irradiation of the energy rays to be emitted from the irradiator 64 in the transfer step (S110) is then controlled based on this data. Nevertheless, if the irradiator 64 only emits monochromatic light or energy rays of narrow wavelength range, the inspection step (S104) may include measuring data from which the irradiation intensity of the energy rays transmitted through the stamper 50 in the transfer step (S110) can be predicted only for the wavelength of the monochromatic energy rays or for wavelengths in the vicinity of the center of the narrow wavelength range. In this instance, the amount of irradiation of the energy rays to be emitted from the irradiator 64 in the transfer step (S110) may be controlled based on this data. Besides, if curing coefficients for some wavelength components of the energy rays emitted from the irradiator 64 are significantly high and those for the other wavelength components are significantly low, the inspection step (S104) may include measuring data from which the irradiation intensities of the energy rays transmitted through the stamper 50 in the transfer step (S110) can be predicted only for the wavelengths of the plurality of wavelength components, for which the curing coefficients are significantly high. Then, the amount of irradiation of the energy rays to be emitted from the irradiator 64 in the transfer step (S110) may be controlled based on this data.

Moreover, if the stamper 50 decreases in transmittance uniformly across all the wavelengths, the data from which the irradiation intensities of the energy rays transmitted through the stamper 50 in the transfer step (S110) can be predicted may also be measured at one wavelength alone. Then, the amount of irradiation of the energy rays to be emitted from the irradiator 64 in the transfer step (S110) may be controlled based on this data.

The first and second exemplary embodiments have dealt with the cases where the use limit of the stamper is distinguished (S106) and the amount of irradiation of the energy rays in the transfer step (S110) is controlled based on the result of inspection in the inspection step (S104) or the number of times of use of the stamper 50 checked in the use number checking step (S202). Nevertheless, either one of these processes may be omitted so that the other process is performed alone.

Similarly, the third and fourth exemplary embodiments have dealt with the cases where the use limit of the stamper is distinguished (S106) or (S402), the amount of irradiation of the energy rays in the transfer step (S110) is controlled, and the presence or absence of the resin material 28 adhering to the stamper 50 is distinguished (S304) based on the result of inspection of the inspection step (S104) or (S302). Any one or two of these processes may be omitted so that the remaining one or two processes are performed alone.

In the first, third, and fourth exemplary embodiments, the inspection instrument 66 is composed of the projector 66A and the photoreceiver 66B. The irradiator 64 may be used instead of the projector 66A, however, and the inspection instrument may be configured so that the photoreceiver measures the irradiation intensities of the energy rays emitted from the irradiator 64, without the provision of the projector 66A. In this case, the irradiation intensities and the wavelength distribution characteristic of the energy rays transmitted through the stamper 50 in the transfer step (S110) can be predicted directly from the irradiation intensities of the energy rays transmitted through the stamper 50, measured in the inspection step (S104) or (S302), without calculating the transmittances of the stamper 50.

In the first, third, and fourth exemplary embodiments, the inspection instrument 66 is incorporated into the transfer apparatus 60. The transfer apparatus and the inspection instrument may be installed separately, however.

The first to fourth exemplary embodiments have dealt with the cases where the stamper 50 and the stamper stage 62 are configured separately from each other, so that they are lowered to the top of the object to be processed 10 in sequence. Nevertheless, the stamper stage may retain the light-transmitting stamper by negative pressure or by adhesion so that they are integrally lowered to the top of the object 10 at the same time.

In the first and third exemplary embodiments, the inspection step (S104) is performed between the resin layer application step (S102) and the transfer step (S106). In the second exemplary embodiment, the use number checking step (S202) is performed between the resin layer application step (S102) and the transfer step (S106). Nevertheless, the inspection step (S104) or the use number checking step (S202) may be performed before the resin layer application step (S102) as in the fourth exemplary embodiment.

The first to fourth exemplary embodiments have dealt with the cases where a plurality of magnetic recording media 30 are manufactured by using one single stamper 50 continuously and repeatedly. A plurality of stampers 50 may be used on a single manufacturing line, however. For example, the inspection step (S104) may be performed on one of the stampers 50 while the transfer step (S110) is performed by using another stamper 50. This can improve the production efficiency.

In the first to fourth exemplary embodiments, the soft magnetic layer 16 and the seed layer 18 are formed under the recording layer 20 (32). Nevertheless, the configuration of the layers under the recording layer 20 (32) may be modified as appropriate depending on the type of the magnetic recording medium. For example, an antiferromagnetic layer and/or an underlayer may be formed under the soft magnetic layer 16. Either one of the soft magnetic layer 16 and the seed layer 18 may be omitted. The recording layer 20 (32) may be formed on the substrate 12 directly.

In the first to fourth exemplary embodiments, the recording layer 20 is completely divided in the recording layer processing step (S112). Nevertheless, the recording layer may be processed halfway in the thickness direction, thereby forming a recording layer of concavo-convex pattern continuing under concave portions.

The first to fourth exemplary embodiments have dealt with the cases where the recording layer 20 is processed into a concavo-convex pattern. Nevertheless, the substrate may be processed into a concavo-convex pattern so that a recording layer of concavo-convex pattern is formed by depositing the recording layer along the substrate of concavo-convex pattern.

The first to fourth exemplary embodiments have dealt with the cases where the recording layer 32 is formed on one side of the substrate 12. Nevertheless, the present invention is also applicable when manufacturing a magnetic recording medium that has recording layers on both sides of its substrate.

In the first to fourth exemplary embodiments, the magnetic recording medium 30 is a discrete track medium of perpendicular recording type in which the recording elements 32A in the data area are formed in the shape of tracks. Nevertheless, the present invention is also applicable when manufacturing a patterned medium in which recording elements are formed in the shape of circumferentially divided tracks, and when manufacturing a magnetic disk in which recording elements are formed in a spiral configuration. In addition, the present invention is also is applicable the manufacturing of optical recording discs such as MO (Magneto-Optical), recording disks of thermally assisted type in which magnetism and heat are used in combination, and magnetic recording media of non-disk configuration such as a magnetic tape.

The first to fourth exemplary embodiments have dealt with the cases of manufacturing a magnetic recording medium. Nevertheless, the present invention is also applicable when forming a spacer layer of an optical recording medium that has two or more recording layers, for example. The present invention may also be applied to the manufacturing of objects other than information recording media, such as semiconductors.

### WORKING EXAMPLE

As in the foregoing first exemplary embodiment, 100 sheets of magnetic recording media 30 were manufactured by using the same stamper 50.

For the resin material 28, a resin material made of urethane acrylate oligomer and pentaerythritol triacrylate monomer diluted with a propylene glycol monomethyl ether acetate (PGMEA) solvent, containing IRGACURE 819 as a photopolymerization initiator additive, was used. Excluding the solvent, the weight ratios of urethane acrylate oligomer, pentaerythritol triacrylate monomer, and the photopolymerization initiator were 45:54:1. FIG. 5 shows the absorption characteristic of this resin material. The stamper 50 was made of polyolefin. The irradiator 64 was a metal halide lamp having the wavelength distribution characteristic shown in FIG. 7.

In the inspection step (S104), data from which the irradiation intensities of the energy rays transmitted through the stamper 50 in the transfer step (S110) can be predicted was measured at 15 possible values of wavelength within the range of 365 to 505 nm at intervals of 10 nm. Specifically, the measurement was performed for the relative irradiation intensities (wavelength distribution characteristic) of the respective wavelength components of the energy rays with which the projector 66A irradiated the photoreceiver 66B directly, and the relative irradiation intensities (wavelength distribution characteristic) of the respective wavelength components of the energy rays with which the projector 66A irradiated the photoreceiver 66B through the stamper 50. FIG. 8 shows the transmittance characteristic of the stamper 50 which is calculated based on the relative irradiation intensities measured in the inspection step (S104) when manufacturing the eleventh magnetic recording medium 30. The projector 66A was a metal halide lamp of the same type as the irradiator 64.

In the transfer step (S110), curing coefficients for the respective wavelength components of the energy rays were calculated based on the wavelength distribution characteristic of the energy rays transmitted through the stamper 50 in the transfer step (S110), determined from the data measured in the inspection step (S104), and the absorption characteristic of the resin material 28. Here, the curing coefficients are the products obtained by multiplying the relative irradiation intensities corresponding to the amounts of irradiation per unit time of the energy rays transmitted through the stamper 50 in the transfer step (S110), by the relative absorbances corresponding to the relative rates of absorption of the resin material 28 to the energy rays. The calculations were then summed into an integrated curing coefficient.

Incidentally, the reference integrated curing coefficient, the integrated curing coefficient for the case where the irradiator 64 irradiates the resin material 28 with the energy rays directly without the intervention of the stamper 50, was calculated in advance. Moreover, the reference amount of irradiation, that is the appropriate amount of irradiation for curing the resin material 28 sufficiently when the irradiator 64 irradiates the resin material 28 of the object to be processed 10 with the energy rays directly without the intervention of the stamper 50, was also measured in advance by experiment.

The irradiator 64 was controlled so that the amount of irradiation of the energy rays emitted from the irradiator 64 exceeded the reference amount of irradiation in proportion to the ratio obtained by dividing this reference integrated curing coefficient by the integrated curing coefficient that was calculated from the data measured in the inspection step (S104). More specifically, the irradiation time of the energy rays was controlled.

Under the foregoing conditions, the 100 sheets of magnetic recording medium 30 were manufactured by using the same stamper 50. Table 1 shows: the relative irradiation intensities (wavelength distribution characteristic) of the energy rays yet to be transmitted through the stamper 50 in the transfer step (S110); the relative absorbances (absorption characteristic) of the resin material 28; the curing coefficients and the reference integrated curing coefficient when the irradiator 64 irradiated the resin material 28 with the energy rays directly without the intervention of the stamper 50; the transmittances of the stamper 50 to the respective wavelength components of the energy rays, calculated from the data measured in the inspection step (S104); the relative irradiation intensities (wavelength distribution characteristic) of the energy rays transmitted through the stamper 50 in the transfer step (S110), calculated from the foregoing transmittances; and the curing coefficients and the integrated curing coefficients calculated based on these. Note that the shown data on the relative irradiation intensities of the energy rays transmitted through the stamper 50 in the transfer step (S110), the transmittances of the stamper 50, the curing coefficients, and the integrated curing coefficients are of the first, sixth, eleventh, and twenty-first manufacturing operations.

TABLE 1

| | Relative | | | First time | | | Sixth time | | |
|---|---|---|---|---|---|---|---|---|---|
| | irradiation | | | | Relative | | | Relative | |
| | intensity | | | | irradiation | | | irradiation | |
| | before | | Curing | | intensity after | | | intensity after | |
| | transmission | | coefficient | | transmission | | | transmission | |
| Wavelength | through | Relative | without | Trans- | through | Curing | Trans- | through | Curing |
| nm | stamper | absorbance | stamper | mittance | stamper | coefficient | mittance | stamper | coefficient |
| 365 | 89.6 | 1.949 | 174.630 | 0.90 | 80.8 | 157.459 | 0.88 | 78.8 | 153.512 |
| 375 | 99.7 | 2.022 | 201.593 | 0.92 | 91.3 | 184.677 | 0.89 | 89.2 | 180.358 |
| 385 | 88.5 | 1.798 | 159.123 | 0.92 | 81.4 | 146.419 | 0.87 | 77.1 | 138.645 |
| 395 | 36.3 | 1.579 | 57.318 | 0.92 | 33.3 | 52.557 | 0.87 | 31.7 | 50.035 |
| 405 | 39.9 | 1.166 | 46.523 | 0.92 | 36.5 | 42.610 | 0.87 | 34.7 | 40.433 |
| 415 | 36.9 | 0.717 | 26.457 | 0.92 | 33.8 | 24.260 | 0.91 | 33.4 | 23.974 |
| 425 | 42.6 | 0.407 | 17.338 | 0.92 | 39.0 | 15.875 | 0.91 | 38.7 | 15.757 |
| 435 | 41.5 | 0.134 | 5.561 | 0.92 | 38.0 | 5.092 | 0.91 | 37.8 | 5.069 |
| 445 | 18.0 | 0.030 | 0.540 | 0.92 | 16.5 | 0.495 | 0.91 | 16.5 | 0.494 |
| 455 | 9.8 | 0.000 | 0.000 | 0.92 | 9.0 | 0.000 | 0.91 | 9.0 | 0.000 |
| 465 | 7.7 | 0.000 | 0.000 | 0.92 | 7.1 | 0.000 | 0.92 | 7.0 | 0.000 |
| 475 | 5.2 | 0.000 | 0.000 | 0.92 | 4.8 | 0.000 | 0.92 | 4.8 | 0.000 |
| 485 | 19.9 | 0.000 | 0.000 | 0.92 | 18.3 | 0.000 | 0.92 | 18.2 | 0.000 |
| 495 | 18.9 | 0.000 | 0.000 | 0.92 | 17.4 | 0.000 | 0.92 | 17.3 | 0.000 |
| 505 | 11.5 | 0.000 | 0.000 | 0.92 | 10.5 | 0.000 | 0.91 | 10.5 | 0.000 |

| | | | | | |
|---|---|---|---|---|---|
| Reference integrated curing coefficient | 689.084 | Integrated curing | 629.445 | Integrated curing | 608.277 |
| | | coefficient | | coefficient | |

| | Relative | | Eleventh time | | | Twenty-first time | | |
|---|---|---|---|---|---|---|---|---|
| | irradiation | | | Relative | | | Relative | |
| | intensity | | | irradiation | | | irradiation | |
| | before | | | intensity after | | | intensity after | |
| | transmission | | | transmission | | | transmission | |
| Wavelength | through | Relative | | through | Curing | | through | Curing |
| nm | stamper | absorbance | Transmittance | stamper | coefficient | Transmittance | stamper | coefficient |
| 365 | 89.6 | 1.949 | 0.87 | 78.0 | 152.002 | 0.86 | 77.2 | 150.398 |
| 375 | 99.7 | 2.022 | 0.88 | 87.8 | 177.608 | 0.84 | 83.9 | 169.721 |
| 385 | 88.5 | 1.798 | 0.87 | 76.7 | 137.889 | 0.80 | 71.0 | 127.664 |
| 395 | 36.3 | 1.579 | 0.86 | 31.3 | 49.346 | 0.82 | 29.8 | 46.998 |
| 405 | 39.9 | 1.166 | 0.86 | 34.4 | 40.077 | 0.82 | 32.7 | 38.134 |
| 415 | 36.9 | 0.717 | 0.90 | 33.3 | 23.880 | 0.88 | 32.4 | 23.246 |
| 425 | 42.6 | 0.407 | 0.90 | 38.5 | 15.688 | 0.89 | 37.8 | 15.397 |
| 435 | 41.5 | 0.134 | 0.91 | 37.7 | 5.056 | 0.89 | 37.1 | 4.974 |
| 445 | 18.0 | 0.030 | 0.91 | 16.4 | 0.493 | 0.90 | 16.2 | 0.485 |
| 455 | 9.8 | 0.000 | 0.91 | 9.0 | 0.000 | 0.90 | 8.8 | 0.000 |
| 465 | 7.7 | 0.000 | 0.92 | 7.0 | 0.000 | 0.90 | 6.9 | 0.000 |
| 475 | 5.2 | 0.000 | 0.92 | 4.8 | 0.000 | 0.91 | 4.7 | 0.000 |
| 485 | 19.9 | 0.000 | 0.92 | 18.2 | 0.000 | 0.91 | 18.1 | 0.000 |
| 495 | 18.9 | 0.000 | 0.92 | 17.3 | 0.000 | 0.91 | 17.2 | 0.000 |
| 505 | 11.5 | 0.000 | 0.91 | 10.5 | 0.000 | 0.91 | 10.4 | 0.000 |

| | | | | |
|---|---|---|---|---|
| Reference integrated curing coefficient | Integrated curing coefficient | 602.039 | Integrated curing coefficient | 577.018 |

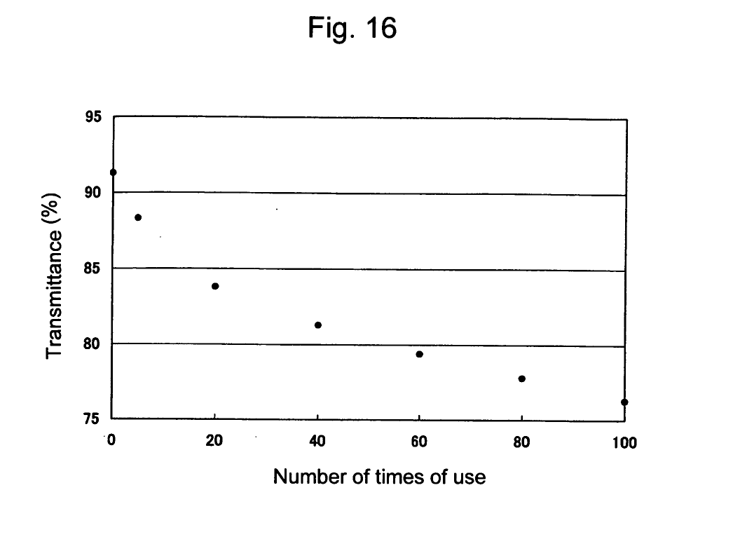

FIG. 16 is a graph showing the relationship between the number of times of use of the stamper 50 and the transmittance of the stamper 50. Each of the transmittance values shown in FIG. 16 is determined by dividing the sum of the products, which is obtained by multiplying the transmittances by the curing coefficients of the respective wavelength components, by the integrated curing coefficient.

As shown in FIG. 16 and Table 1, the transmittance of the stamper 50 decreased as the number of times of use of the stamper 50 increased. The integrated curing coefficient also decreased as the number of times of use of the stamper 50 increased.

On the other hand, all the 100 sheets of magnetic recording medium 30 were manufactured successfully, with the resin material 28 sufficiently cured in the transfer step (S110). The reason for this is considered to be that the resin material 28 was irradiated with the appropriate amount of irradiation of the energy rays since the result of inspection on the optical characteristics of the stamper 50 was fed back to the control of the irradiator 64.

It should be noted that the stamper 50 is desirably replaced when the transmittance of the stamper 50 falls to around 75%.

What is claimed is:

1. A method for manufacturing an information recording medium, comprising:
an inspection step of inspecting a stamper made of a light-transmitting resin, having a predetermined concavo-convex pattern formed on a transfer area thereof, for an optical characteristic; and
a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein
the stamper is used a plurality of times to repeat the steps a plurality of times, thereby manufacturing a plurality of information recording media.

2. The method for manufacturing an information recording medium according to claim 1, wherein the inspection step includes measuring data from which an irradiation intensity of the energy ray transmitted through the stamper in the transfer step can be predicted as the optical characteristic of the stamper.

3. The method for manufacturing an information recording medium according to claim 1, wherein an amount of irradiation of the energy ray to irradiate the resin material with is controlled in the transfer step, based on the result of inspection on the optical characteristic of the stamper in the inspection step.

4. The method for manufacturing an information recording medium according to claim 2, wherein an amount of irradiation of the energy ray to irradiate the resin material with in the transfer step is controlled based on the result of inspection on the optical characteristic of the stamper in the inspection step.

5. The method for manufacturing an information recording medium according to claim 3, wherein:
the inspection step includes measuring data from which a wavelength distribution characteristic of the energy ray transmitted through the stamper in the transfer step can be predicted; and
the transfer step includes controlling the amount of irradiation of the energy ray based on the wavelength distribution characteristic of the energy ray predicted from the data and an absorption characteristic of the resin material to the energy ray.

6. The method for manufacturing an information recording medium according to claim 1, further comprising
a use limit distinction step of distinguishing a use limit of the stamper based on the result of inspection on the optical characteristic of the stamper in the inspection step.

7. The method for manufacturing an information recording medium according to claim 2, further comprising
a use limit distinction step of distinguishing a use limit of the stamper based on the result of inspection on the optical characteristic of the stamper in the inspection step.

8. The method for manufacturing an information recording medium according to claim 1, further comprising
an adhering resin material distinction step of distinguishing presence or absence of the resin material adhering to the stamper in the transfer step that is performed prior to the inspection step, based on the result of inspection on the optical characteristic of the stamper in the inspection step.

9. The method for manufacturing an information recording medium according to claim 1, wherein the inspection step is performed after the transfer step, the method further comprising
an adhering resin material distinction step of distinguishing presence or absence of the resin material adhering to the stamper in the transfer step, based on the result of inspection on the optical characteristic of the stamper in the inspection step.

10. A method for manufacturing an information recording medium, comprising:
a use number checking step of checking the number of times of use of a stamper made of a light-transmitting resin, having a predetermined concavo-convex pattern formed on a transfer area thereof; and
a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein
the stamper is used a plurality of times to repeat these steps a plurality of times, thereby manufacturing a plurality of information recording media, and an amount of irradiation of the energy ray to irradiate the resin material with is controlled in the transfer step, based on the number of times of use of the stamper.

11. A method for transferring a concave-convex pattern, comprising:
an inspection step of inspecting a stamper made of a light-transmitting resin, having a predetermined concavo-convex pattern formed on a transfer area thereof, for an optical characteristic; and
a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein
the stamper is used a plurality of times to repeat the steps a plurality of times.

12. A method for transferring a concave-convex pattern, comprising:
a use number checking step of checking the number of times of use of a stamper made of a light-transmitting resin, having a predetermined concavo-convex pattern formed on a transfer area thereof; and
a transfer step of bringing the stamper into contact with an energy-ray curable resin material applied to an object to be processed, thereby transferring the concavo-convex pattern to the resin material, and irradiating the resin material with an energy ray through the stamper so that the resin material cures, wherein
the stamper is used a plurality of times to repeat these steps a plurality of time, and an amount of irradiation of the energy ray to irradiate the resin material with is controlled in the transfer step, based on the number of times of use of the stamper.

13. A transfer apparatus comprising: an irradiator capable of irradiating an object to be transferred with a predetermined energy ray through a stamper made of a light-transmitting resin, having a predetermined concavo-convex pattern formed on a transfer area thereof;
an inspection instrument capable of inspecting the stamper for an optical characteristic; and
a controller capable of controlling an amount of irradiation of the irradiator based on the optical characteristic of the stamper.

14. The transfer apparatus according to claim 13, wherein:
the inspection instrument is capable of measuring data from which a wavelength distribution characteristic of the energy ray transmitted through the stamper can be predicted; and
the controller is capable of controlling the amount of irradiation of the energy ray based on the wavelength distribution characteristic of the energy ray predicted from the data and an absorption characteristic of the object to be transferred to the energy ray.
